(19) United States
(12) Patent Application Publication
(10) Pub. No.: US 2014/0151918 A1
(43) Pub. Date: Jun. 5, 2014

(54) METHOD FOR PRODUCING A SOLE OR A SOLE PART OF A SHOE

(71) Applicant: Matthias Hartmann, Forchheim (DE)

(72) Inventor: Matthias Hartmann, Forchheim (DE)

(73) Assignee: PUMA SE, Herzogenaurach (DE)

(21) Appl. No.: 14/235,676

(22) PCT Filed: Jul. 16, 2012
(86) PCT No.: PCT/EP2012/002970

§ 371 Date: Jan. 28, 2014

(30) Foreign Application Priority Data
Jul. 28, 2011 (DE) 10 2011 108 744.7

(51) Int. Cl. B29D 35/06

(52) U.S. Cl. CPC B29D 35/06
USPC 264/46.5

(57) ABSTRACT

The invention relates to a method or producing a sole (1) or a sole part of a shoe (2), in particular of a sports shoe. To obtain a lightweight shoe which has good rebound characteristics, the invention provides the following steps: a) Producing plastic elements (3), the extent (a, b, c) of which in the three spatial direction lies between 2 mm and 15 mm, preferably between 3 mm and 9 mm, wherein the plastic elements (3) consist of a foamed thermoplastic elastomer based on urethane (TPU, E-TPU, TPE-U) and/or based on polyether block amide (PEBA); b) Introducing the plastic elements (3) into a moulding tool which has a cavity which corresponds to the shape of the sole (1) or the sole part to be produced; c) Connecting the plastic elements (3) located in the moulding tool to one another, wherein a binder is put into the moulding tool to make the connection and/or wherein heat is allowed to act on the plastic elements (3) to make the connection.

### CROSS-REFERENCE TO RELATED APPLICATIONS

This application is a 371 of PCT/EP2012/002970 filed Jul. 16, 2012, which in turn claims the priority of DE 10 2011 108 744.7 filed Jul. 28, 2011, the priority of both applications is hereby claimed and both applications are incorporated by reference herein.

The invention relates to a method for producing a sole or a sole part of a shoe, in particular of a sports shoe.

At the production of shoe soles it is sufficiently known, to inject and pour respectively the plastic material in a molten state into the cavity of a molding tool to obtain thereby the desired form of the sole.

The selection of the plastic material leads to such, that within certain boundaries the weight and the density respectively of the midsole can be influenced as well as its resetting properties (i. e. the manner how the bended sole moves itself back into the origin position).

It is known from US 2011/0047720 A1 to produce a shoe sole by using pellets which are connected with another by the impact of heat. FR 2 357 357 A1 discloses the production of a shoe sole from foamed polyurethane.

It is an object of the invention, to provide a method, by which the weight of the sole and its resetting properties respectively can be influenced in a more effective way. Accordingly a particular light shoe shall be producible as well as such a shoe, which distinguishes itself by a good resetting property, due to the low weight of the sole.

The solution of this object by the invention is characterized in that the method proposes the steps of:
a) Producing plastic elements, the extent of which in the three spatial direction lies between 2 mm and 15 mm, preferably between 3 mm und 9 mm, wherein the plastic elements consist of a foamed thermoplastic elastomer based on urethane (TPU, E-TPU, TPE-U) and/or based on polyether block amide (PEBA);
b) Introducing the plastic elements into a moulding tool which has a cavity which corresponds to the shape of the sole or the sole part to be produced;
c) Connecting the plastic elements located in the moulding tool to one another, wherein heat is allowed to act on the plastic elements to make the connection, by conducting of steam under pressure into the moulding tool.

Thereby, the plastic elements have preferably a globular or ellipsoid shape; also a kidney-shape has proven.

The base material for the production of the plastic elements has preferably a hardness between 75 and 90 Shore A, specifically preferred between 80 and 85 Shore A. The plastic elements have preferably a bulk density between 100 and 300 kg/m³, this depends on the size of the plastic elements.

The connecting of the plastic elements according to above step c) thus occurs by conducting of steam under pressure into the moulding tool. Thereby it was proven when the pressure of the steam lies between 1.6 and 2.4 bar (1 bar=10⁵ N/m²), preferably between 1.9 and 2.1 bar.

It is possible with the proposed solution to produce the entire sole of the shoe. But it is also possible to produce only a part of it, in particular a midsole of the shoe.

Thermoplastic elastomer on the basis of urethane, which is proper for the use of the present invention, is known in the state of the art as such and is available on the market. In this regard reference is made explicitly to WO 2010/010010 A1 for example, in which an expandable thermoplastic polymer blend containing a blowing agent is disclosed, which contains thermoplastic polyurethane and styrene polymer. The polymer blend can thereby contain at least one further thermoplastic polymer. As a further thermoplastic polymer polyamide (PA), polymethyl methacrylate (PMMA), polycarbonate (PC), polyethylene (PE), polypropylene (PP), polyvinylchloride (PVC), cellulose and polyoxymethylene (POM) are in particular possible. Proposals for the material are also made in FR 2 097 144 A1 where especially the production of foamed materials is an issue. Foamable material in the form of pellets is also described in US 2011/0294910 A1.

As already mentioned, the whole sole as well as only a part of the same—particularly the midsole or outer sole—can be produced according to the invention. It is also. possible that sandals are produced in such way, wherein the sole requires then only a holding band for the foot. Also possible is the application of a produced sole part according to the invention as a substitute for foam in the shoe and in the sole respectively (e. g. in form of an insole).

In the drawing an embodiment of the invention is depicted. It shows:

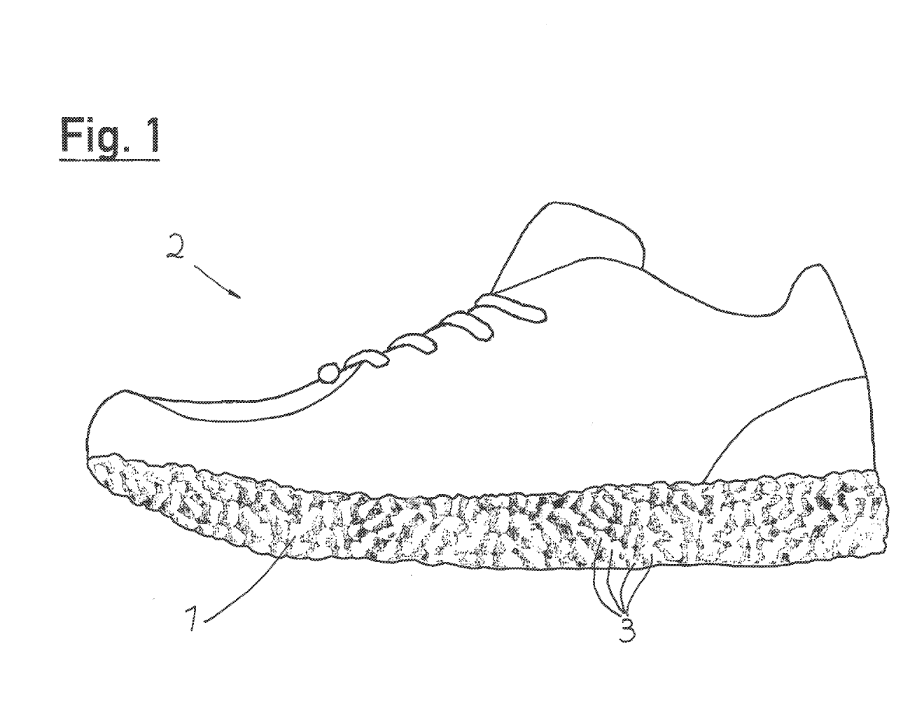

FIG. 1 the side view of a shoe which comprises a sole according to the invention and

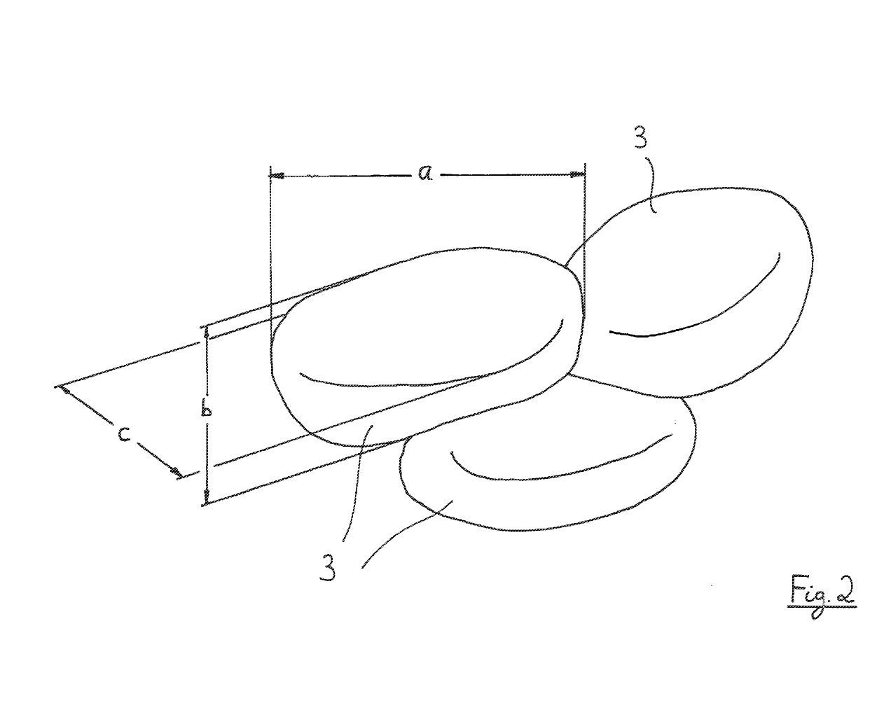

FIG. 2 schematically three; plastic elements being a part of the sole of the shoe.

In FIG. 1 a shoe 2 can be seen, which comprises a sole 1. Presently, the entire sole 1 consists of a body which is produced from plastic material, which components are plastic elements 3, which are depicted in FIG. 2 in more detail.

The plastic elements 3 are designed globular, ellipsoid or kidney-shaped; in FIG. 2 ellipsoid plastic elements 3 are depicted. Each plastic element 3 extends along an extent a, b and c respectively in the three spatial directions. According to the invention it is provided that the value for the extents a, b and c lies between 2 mm and 15 mm, wherein particularly values between 3 mm and 9 mm have proven itself of value.

For the permanent connection of the individual plastic elements two preferred possibilities are basically at hand.

The first possibility intercepts that the individual plastic elements are connected and glued respectively with each other by a binder.

The mixture part of the binder (glue) is (including the existing color, if applicable) at least 5 weight-%; accordingly 95 weight-% of foamed plastic elements (pellets) would be then at hand. A percentage of 30 weight-% of binder is not exceeded most of the time, although the method works also with a higher percentage of the binder.

The binder should be resisting to yellowing and should be elastically as possible.

As a binder, a polyurethane foam can be also applied for example, with which the plastic elements are foamed in, The composition of the mixture of plastic elements and PU-foam can be chosen so that a desired density results. Those of the PU-foam lays between 250 kg/m³ and 600 kg/m³; the plastic elements are added, which are chosen to their size accordingly. The advantage of this solution consists in such that the PU-foam is very flexible and light and stronger in the composite. However the PU-foam is not transparent, which can be disadvantageous in consideration of the optical appearance of the sole as the case may be.

The second possibility applies to a welding of the individual plastic elements at their contact point.

A preferred possibility is the feeding of steam, but also a direct impact of heat is possible, which let the plastic bodies melt at their surface.

At a method of a dynamic pressure the plastic elements will be compressed before the insertion of steam first with a dynamic pressure of 3 to 5 bar, preferably of 4 bar.

At a method of cracking the plastic elements will be given uncompressed into the cavity of the moulding tool and then steam will be inserted.

Typical obtained densities of the sole material are thereby values between 50 kg/m³ and 180 kg/m³; for the application of outer soles and midsoles respectively a preferred range from 130 kg/m³ to 140 kg/m³ is previewed. If the method will be used for the production of a sandal, a value will be strived for between 110 kg/m³ and 120 kg/m³ of the density of the completed sole.

According to an alternative method, the plastic elements can also be filled into a recess in a sole element and can then be provided with a PU-foam.

At all variations the plastic elements will be chosen according to their size, wherein the mentioned border areas have to be considered.

At the execution of the method it will normally be worked with cycle times of the forming process in the moulding tool between 150 and 400 s. The obtained form part density lies between 180 kg/m³ and 320 kg/m³ in dependency of the concrete used method (higher values in the case of the use of the mentioned dynamic pressure).

### LIST OF REFERENCES

1 Sole
2 Shoe
3 Plastic element
a Extent in axial direction
b Extent in axial direction
c Extent in axial direction

### SUMMARY

The invention relates to a method for producing a sole (1) or a sole part of a shoe (2), in particular of a sports shoe. To obtain a lightweight shoe which has good rebound characteristics, the invention provides the following steps: a) Producing plastic elements (3), the extent (a, b, c) of which in the three spatial direction lies between 2 mm and 15 mm, preferably between 3 mm und 9 mm, wherein the plastic elements (3) consist of a foamed thermoplastic elastomer based on urethane (TPU, E-TPU, TPE-U) and/or based on polyether block amide (PEBA); b) Introducing the plastic elements (3) into a moulding tool which has a cavity which corresponds to the shape of the sole (1) or the sole part to be produced; c) Connecting the plastic elements (3) located in the moulding tool to one another, wherein a binder is put into the moulding tool to make the connection and/or wherein heat is allowed to act on the plastic elements (3) to make the connection.

(FIG. 1)

1. Method for producing a sole or a sole part of a shoe, in particular of a sports shoe, comprising the steps:
a) Producing plastic elements, the extent of which in the three spatial direction lies between 2 mm and 15 mm, preferably between 3 mm and 9 mm, wherein the plastic elements consist of a foamed thermoplastic elastomer based on urethane (TPU, E-TPU, TPE-U) and/or based on polyether block amide (PEBA);
b) Introducing the plastic elements into a moulding tool which has a cavity which corresponds to the shape of the sole or the sole part to be produced;
c) Connecting the plastic elements located in the moulding tool to one another, wherein heat is allowed to act on the plastic elements to make the connection, by conducting of steam under pressure into the moulding tool.

2. Method according to claim 1, characterized in that the plastic elements have a globular or ellipsoid shape.

3. Method according to claim 1, characterized in that the base material for the production of the plastic elements has a hardness between 75 and 90 Shore A, preferably between 80 and 85 Shore A.

4. Method according to claim 1, characterized in that the plastic elements have a bulk density between 100 and 300 kg/m³.

5. (canceled)

6. (canceled)

7. (canceled)

8. Method according to claim 1, characterized in that the pressure of the steam lies between 1.6 and 2,4 bar, preferably between 1.9 and 2.1 bar.

9. Method according to claim 1, characterized in that the whole sole of the shoe is produced by the method.

10. Method according to claim 1, characterized in that a midsole of the shoe is produced by the method.
